(19) United States
(12) Patent Application Publication
(10) Pub. No.: US 2002/0119820 A1
(43) Pub. Date: Aug. 29, 2002

(54) Input key for game controller

(76) Inventor: Takaki Tsutsui, Tokyo (JP)

Correspondence Address: LAW OFFICES, WHITHAM, CURTIS & CHRISTOFFERSON, P.C., 11491 SUNSET HILLS ROAD, SUITE 340, P.O. BOX 9204, RESTON, VA, 20190, US

(21) Appl. No.: 10/077,981

(22) Filed: Feb. 20, 2002

(30) Foreign Application Priority Data
Feb. 26, 2001 (JP) P.2001-049694

(51) Int. Cl. A63F 13/00

(52) U.S. Cl. 463/37; 463/38

(57) ABSTRACT

A cursor key case is idly held in a cylindrical holder of a controller case, so as to movable in a predetermined number of plural directions extending from a center point while keeping point symmetry. The cursor key case is provided on a polygonal flange having the predetermined number of plural side end faces, each associated with each of the movable directions. An outer diameter of the cylindrical holder is larger than a dimension between opposing side end faces of the polygonal flange. A top face of the polygonal flange is abutted against a lower end face of the cylindrical holder when the cursor key case is placed in a neutral position. One side end face of the polygonal flange is moved down by operating the cursor key case in one movable direction so that an opposite side end face of the polygonal flange is brought into at least two-point contact with the lower end face of the cylindrical holder.

### BACKGROUND OF THE INVENTION

The present invention relates to an input key for a game controller, and more particularly to the input key for the game controller provided with an eight-direction input cursor key for the game controller, in which retention of the eight-direction input cursor key in the event of input is stabilized and operability is enhanced.

A related input key for a game controller of this type will be described referring to FIGS. 5 to 8. FIG. 5A is a bottom view of an upper case 1 of the game controller. In the drawing, there is formed a key hole 2 for disposing an eight-direction input cursor key therein. Key holes 3 for arranging input keys of various types are appropriately formed in the upper case 1. FIG. 5B is a sectional view of the upper case 1 taken along a line A-A, in which a holding part 4 defining an outer peripheral face of the key hole 2 and extending downwardly is formed in a lower part (an upper part in the drawing) of the key hole 2.

FIG. 6A shows an eight-direction input cursor key 5 which is provided with a cap-shaped key case 7 having a flange 6. Concave grooves 9 in a shape of a cross with a slow curve are formed on an upper face of the input cursor key 5, so that an operator can visually or touchably recognize eight-directions which are crossed with each other at angles of 45 degrees. Moreover, at an outer circumferential edge of the flange 6, there is formed an upright wall 10 erected at a substantially right angle with respect to the flange 6. A bottom plate 8 is engaged with a bottom part of the key case 7 at an engagement portion 11.

FIG. 6B is a perspective view of the input cursor key 5 as seen from the bottom face. On the bottom plate 8 of the input cursor key 5, there are arranged substantially concentrically and substantially at an equal interval, eight switches 12 which are respectively adapted to be operated according to the input eight directions of the input cursor key 5.

FIG. 7A is a plan view of the key case 7, and FIG. 7B is a side view of the key case 7.

FIG. 8 is an explanatory view showing a state that the key case 7 has been idly inserted into the key hole 2 of the upper case 1. The key case 7 is idly inserted into the key hole 2, after the bottom plate (8 in FIG. 6) provided with the switches (12 in FIG. 6) and so on which are not shown in this drawing have been engaged with the key case 7. Thereafter, the key case 7 is urged upwardly from below by an elastic member and retained in a neutral state in such a manner that a distal end portion 4a of the holding part 4 is abutted against the flange 6 of the key case 7 along its entire circumference.

In this state, when one direction of the key case 7 is operated to be inputted, the key case 7 is inclined downwardly in the direction inputted (left side in the figure), and retained in such a manner that the flange 6 in a direction opposite to the input direction is abutted against the distal end portion 4a of the holding part 4 at one point. Such one point abutment provides unstable retention of the key case 7, so that the operator has been unable to obtain a favorable feeling of operation.

### SUMMARY OF THE INVENTION

In view of the above, it is therefore an object of the present invention to provide an input key for the game controller in which the retained state of an input cursor key in the event of input is stabilized for improving the feeling of operation.

In order to achieve the above object, according to the present invention, there is provided an input cursor key for a controller, comprising:

a controller case having a cylindrical holder;

a cursor key case, which is idly held in the cylindrical holder so as to movable in a predetermined number of plural directions extending from a center point while keeping point symmetry; and

a polygonal flange on which the cursor key case is provided, the polygonal flange having the predetermined number of plural side end faces, each associated with each of the movable directions, wherein:

an outer diameter of the cylindrical holder is larger than a dimension between opposing side end faces of the polygonal flange;

a top face of the polygonal flange is abutted against a lower end face of the cylindrical holder when the cursor key case is placed in a neutral position; and

one side end face of the polygonal flange is moved down by operating the cursor key case in one movable direction so that an opposite side end face of the polygonal flange is brought into at least two-point contact with the lower end face of the cylindrical holder.

Consequently, as compared with the one point contact in the related input cursor key, the degree of stabilization of the input cursor key in the retained state is increased, and a favorable feeling of operation can be obtained.

According to the present invention, there is also provided an input cursor key for a controller, comprising:

a controller case having a cylindrical holder;

a cursor key case, which is idly held in the cylindrical holder so as to movable in a predetermined number of plural directions extending from a center point while keeping point symmetry; and

a polygonal flange on which the cursor key case is provided, the polygonal flange having the predetermined number of plural vertices, each associated with each of the movable directions, wherein:

the predetermined number of plural cutouts are formed in a lower end portion of the cylindrical member so as to be associated with the respective movable directions;

a top face of the polygonal flange is abutted against a lower end face of the cylindrical holder when the cursor key case is placed in a neutral position; and

one vertex of the polygonal flange is moved down by operating the cursor key case in one movable direction so that an opposite vertex of the polygonal flange is entered into an associated cutout and held by inner edges of the associated cutout.

Since the entered vertex of the polygonal flange is retained by at least the two point contact, the degree of stabilization of the input cursor key in the retained state is increased, and a favorable feeling of operation can be obtained.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1A is a plan view of a key case according to a first embodiment of the present invention;

FIG. 1B is a side view of the key case of FIG. 1A FIG. 2 is a partial side section view showing a state that the key case of the first embodiment is idly inserted into an upper case of a controller;

FIG. 3A is a vertical sectional view of a key hole of a controller for disposing a key case therein, according to a second embodiment of the present invention;

FIG. 3B is a plan view showing the key hole as seen from a direction of arrows B-B in FIG. 3A;

FIG. 4 is a partial side section view showing a state that the key case is idly inserted into the key hole of FIG. 3A;

Fig. 5A is a bottom view of an upper case of a controller in a related example;

FIG. 5B is a sectional view taken along a line A-A of FIG. 5A;

FIG. 6A is a perspective view of an eight-direction input cursor key in the related example;

FIG. 6B is a perspective view of the related eight-direction input cursor key as seen from a bottom face;

FIG. 7A is a plan view of a key case in the related example;

FIG. 7B is a side view of the related key case; and

FIG. 8 is a partial side section view showing a state that the key case is idly inserted into the upper case of the related controller.

### DETAILED DESCRIPTION OF THE PREFERRED EMBODIMENTS

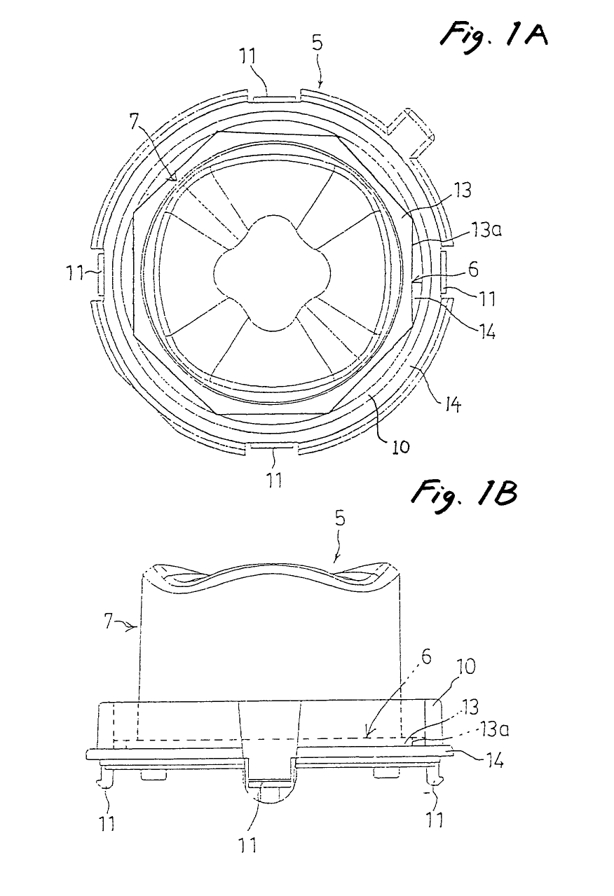

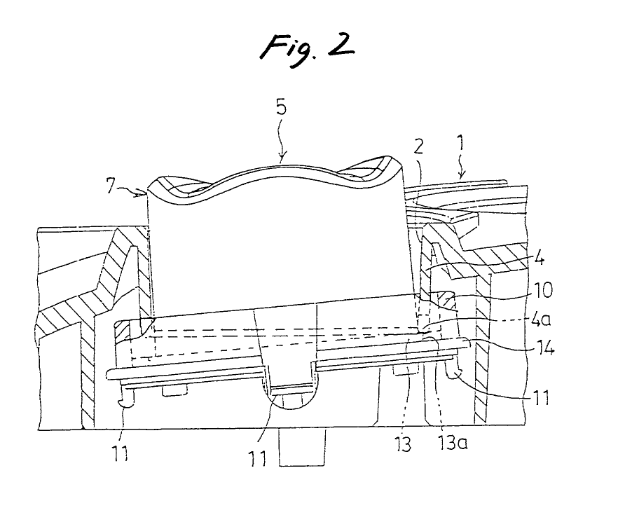

Preferred embodiments according to the present invention will be described in detail referring to FIGS. 1 to 4. For convenience of explanation, same components as in the related example will be denoted with same reference numerals, and their description will be omitted.

As shown in FIGS. 1A and 1B. a key case 7 of an eight-direction input cursor key 5 according to a first embodiment is formed with a two-step flange 6 including an upper flange portion 13 and a lower flange portion 14, and an outer periphery of the upper flange portion 13 is formed in an octagonal shape having eight end faces 13a and eight vertices. Each end face is associated with each operable direction of the input cursor key 5. An upright wall 10 is erected at an outer peripheral end of the lower flange portion 14 in a substantially right angle with respect to the lower flange portion 14.

FIG. 2 shows a state that the key case 7 is idly inserted into a key hole 2 which is formed in an upper case 1 of a controller case. A bottom plate provided with switches and so on is engaged with the key case 7, but not shown in the drawing. When the key case 7 is placed in a neutral position thereof at which the input cursor key 5 is not operated, the key case 7 is retained in such a manner that a top face of the upper flange portion 13 is abutted against an entire circumference of a distal end portion 4a of the holding part 4 while being urged upward by an elastic member (not shown).

When one direction of the input cursor key 5 is operated, the key case 7 is inclined and an associated outer end face 13a is moved downward as shown in FIG. 2. Incidentally, an opposite outer end face 13a is brought into at least two-point contact with the distal end portion 4a of the holding part 4 since the diameter of holding part 4 is larger than a distance between the opposing outer end faces 13a.

Therefore, on this occasion, as compared with the one point contact in the related input cursor key, a degree of stabilization of the key case 7 in the retained state is increased, and a favorable feeling of operation can be obtained.

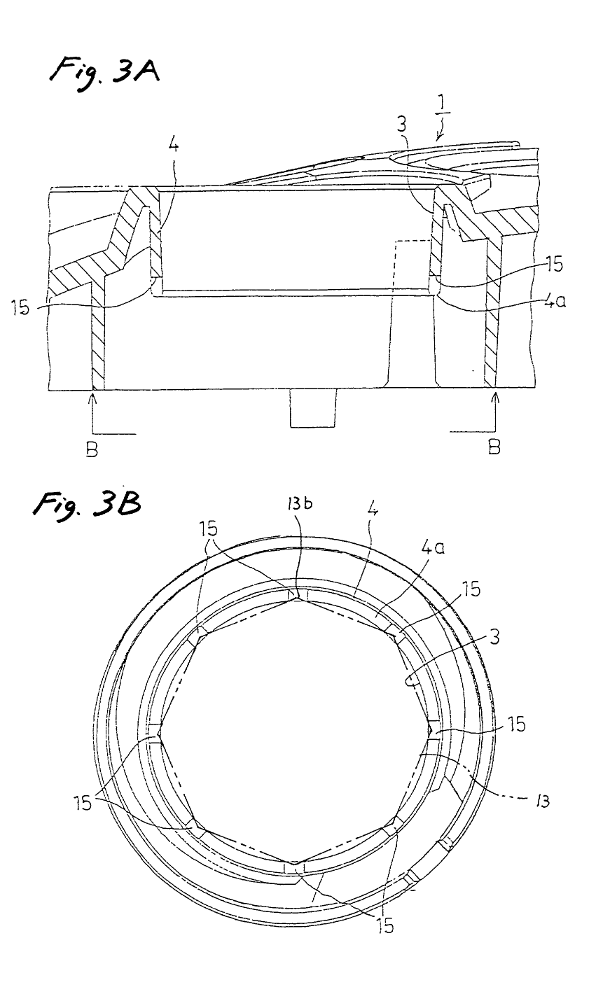

FIGS. 3A and 3B shows an eight-direction input cursor key according to the second embodiment of the invention. For convenience of explanation, same components as in the first embodiment will be denoted with same reference numerals, and their description will be omitted.

In this embodiment, an upper case 1 is formed with eight cut-outs 15 at a distal end portion 4a of a holding part 4 so as to of correspond to eight-directions of the operation of a key case 7. As is represented by phantom lines in FIG. 3B, in this embodiment, each vertex 13b of an octagonal upper flange 13 is associated with each operable direction of the input cursor key 5.

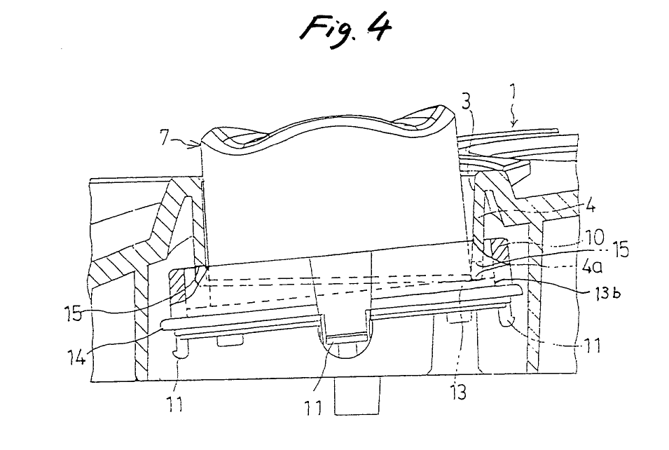

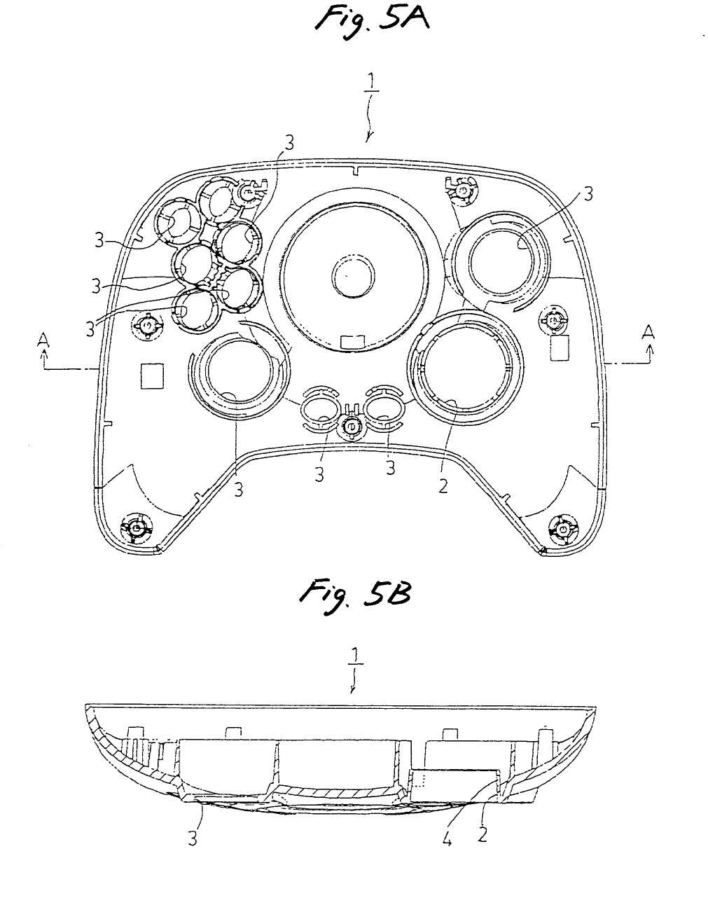

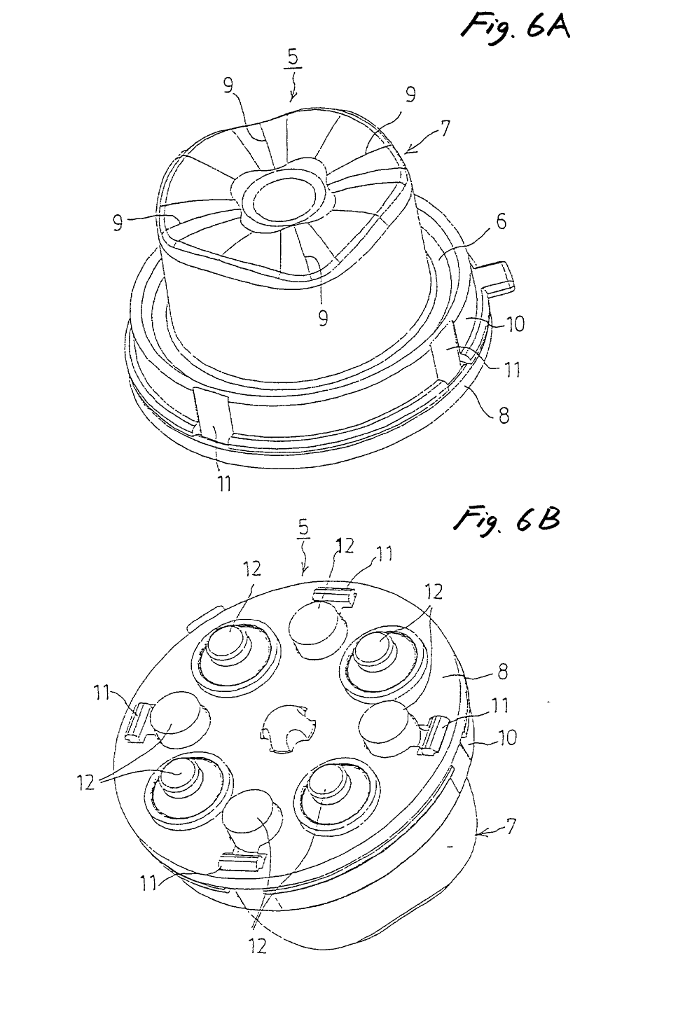

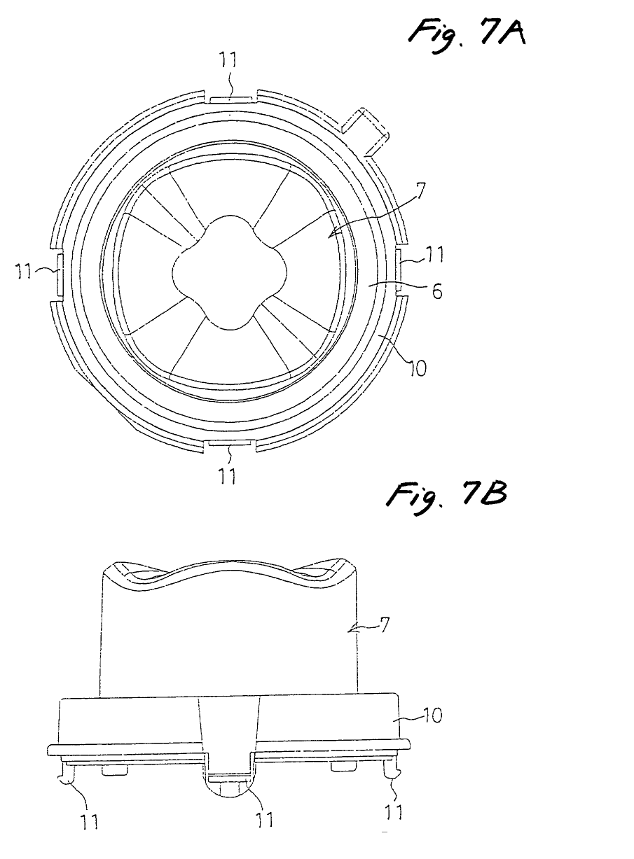

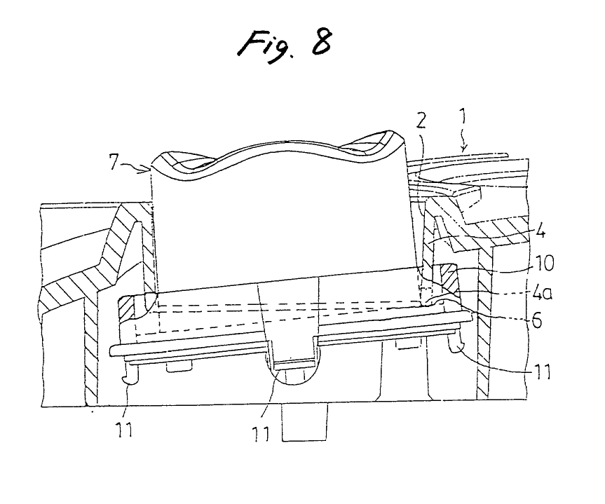

When one direction of the input cursor key 5 is operated, the key case 7 is inclined and an associated vertex 13b is moved downward as shown in FIG. 4. Incidentally, an opposite vertex 13b is entered into the associated cutout 15 while being brought into at least two-point contact with inner edges of the cutout 15.

Therefore, the degree of stabilization of the key case 7 in the retained state is increased owing to the two-point contact, and a favorable feeling of operation can be obtained.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

For example, the number of the operable direction of the input cursor key is not limited to eight. Any number, for example, four or six may be allowed if the directions are extended from one center point while keeping point symmetry.

What is claimed is:

1. An input cursor key for a controller, comprising:
a controller case having a cylindrical holder;
a cursor key case, which is idly held in the cylindrical holder so as to movable in a predetermined number of plural directions extending from a center point while keeping point symmetry; and
a polygonal flange on which the cursor key case is provided, the polygonal flange having the predetermined number of plural side end faces, each associated with each of the movable directions, wherein:
an outer diameter of the cylindrical holder is larger than a dimension between opposing side end faces of the polygonal flange;
a top face of the polygonal flange is abutted against a lower end face of the cylindrical holder when the cursor key case is placed in a neutral position; and
one side end face of the polygonal flange is moved down by operating the cursor key case in one movable direction so that an opposite side end face of the polygonal flange is brought into at least two-point contact with the lower end face of the cylindrical holder.

2. An input cursor key for a controller, comprising:
a controller case having a cylindrical holder;
a cursor key case, which is idly held in the cylindrical holder so as to movable in a predetermined number of plural directions extending from a center point while keeping point symmetry; and
a polygonal flange on which the cursor key case is provided, the polygonal flange having the predetermined number of plural vertices, each associated with each of the movable directions, wherein:
the predetermined number of plural cutouts are formed in a lower end portion of the cylindrical member so as to be associated with the respective movable directions;
a top face of the polygonal flange is abutted against a lower end face of the cylindrical holder when the cursor key case is placed in a neutral position; and
one vertex of the polygonal flange is moved down by operating the cursor key case in one movable direction so that an opposite vertex of the polygonal flange is entered into an associated cutout and held by inner edges of the associated cutout.
